(19) United States
(12) Patent Application Publication
(10) Pub. No.: US 2026/0119382 A1
(43) Pub. Date: Apr. 30, 2026

(54) TEST PROGRAMMING FOR ACTUATOR-BASED TESTING SYSTEMS

(71) Applicant: Illinois Tool Works Inc., Glenview, IL (US)

(72) Inventors: James Foster Knutson, Minnetonka, MN (US); Norman L. Oberski, Chaska, MN (US); Steven Kvidera, Chanhassen, MN (US); Erik Schwarzkopf, Minneapolis, MN (US); Jon A. Wilson, Hopkins, MN (US); Sridhar P. Iyer, Plymouth, MN (US)

(21) Appl. No.: 19/369,971

(22) Filed: Oct. 27, 2025

Related U.S. Application Data
(60) Provisional application No. 63/714,641, filed on Oct. 31, 2024.

(51) Int. Cl. G06F 11/3668

(52) U.S. Cl. CPC G06F 11/3696; G06F 11/3684

(57) ABSTRACT

In a computer-implemented method for generating a test program for a testing system, a graphical user interface is provided on a display device that includes a plurality of workflow elements. The workflow elements include test controls and one or more workflow controls including a group workflow. A test workflow is created by adding a first plurality of the test controls to the test workflow; defining parameters of the first plurality of the test controls; adding the group workflow to the test workflow; adding a second plurality of the test controls to the group workflow of the test workflow; and defining parameters of the second plurality of the test controls. The test program is created based on the test workflow, which includes instructions for performing a test operation corresponding to the test workflow. The test program is saved in a non-transitory computer readable medium.

### CROSS-REFERENCE TO RELATED APPLICATION(S)

The present application is based on and claims the benefit of U.S. provisional patent application Ser. No. 63/714,641, filed Oct. 31, 2024, the content of which is hereby incorporated by reference in its entirety.

### FIELD

Embodiments of the present disclosure generally relate to actuator-based testing systems and, more particularly, to generating test programs that control actuator-based testing systems to perform a test operation.

### BACKGROUND

Actuator-based testing systems, such as those developed by MTS Systems Corporation, may be used to test materials and devices. For example, such testing systems may provide vehicle testing through the application of simulated driving conditions to a mobile vehicle or vehicle component, building testing through the application of simulated seismic activity to a building, and other device and materials testing. The testing systems perform such testing using test machines that include one or more controllable elements (e.g., actuators) that apply a displacement or a load to a test specimen, and test sensors that measure aspects of a response from the test specimen and/or to provide feedback for controlling the test.

The test operations are controlled based on a test program, which a user may create through a graphical user interface (GUI) of a program generator. The test program generally includes a test flow that defines various process steps that are to be performed during the test operation. The test flow can be complicated, with conditional branching, parallel procedures, loop back, and many more different configurations of the process flow.

The process steps defined by the test flow may include, for example, controlling a controllable element to apply a load and/or a displacement to a specimen, acquiring test data from one or more of the test sensors (e.g., a displacement, force, etc.), performing a calculation based on the acquired test data (e.g., calculate strain), and other process steps. The process steps may also involve the writing of certain types of data during the test operation to a computer-readable medium, such as sensor data and calculated data, for example.

### SUMMARY

Embodiments of the present disclosure relate to systems and methods for generating test programs that control actuator-based testing systems to perform a test operation.

One embodiment is directed to a computer-implemented method for generating a test program for a testing system, in which a graphical user interface (GUI) is provided on a display device and includes a plurality of workflow elements. The workflow elements include: test controls including one or more controllable element activities each used to control an aspect of a test machine of the testing system relating to the application of a load and/or displacement to a specimen using a controllable element of the test machine during a test operation, and one or more data activities each relating to monitoring or acquiring data generated during a test operation; and one or more workflow controls each configured to control a path along which process steps are performed including a group workflow. A test workflow is created in a test workflow window of the GUI including: adding a first plurality of the test controls to the test workflow based on user input to the GUI; defining parameters of the first plurality of the test controls based on user input to the GUI; adding the group workflow to the test workflow based on user input to the GUI; adding a second plurality of the test controls to the group workflow of the test workflow based on user input to the GUI; and defining parameters of the second plurality of the test controls based on user input to the GUI. The test program is created based on the test workflow, which includes instructions for performing a test operation corresponding to the test workflow. The test program is saved in a non-transitory computer readable medium.

In one embodiment, the method includes saving the group workflow of the test workflow to a non-transitory computer-readable medium based on user input to the GUI to form a saved group workflow having defined parameters.

In one embodiment, the test controls and the saved group workflow is presented in the GUI.

In one embodiment, the GUI includes one or more saved group workflows, each saved group workflow comprising a group test workflow that includes a plurality of the test controls each having defined parameters, and creating the test program comprises adding one of the saved group workflows to the primary test workflow based on user input to the GUI.

In one embodiment, the method includes moving the group workflow within the test workflow to another location within the test workflow based on user input to the GUI.

In one embodiment, the controllable element comprises an actuator, and adding the second plurality of the test controls to the group workflow of the test workflow includes adding one or more of the controllable element activities to the group workflow of the test workflow selected from the group consisting of a dwell activity, a ramp activity, a cycle activity and a custom waveform activity.

In one embodiment, adding the second plurality of the test controls to the group workflow of the test workflow includes adding one or more of the data activities to the group workflow of the test workflow selected from the group consisting of: a data acquisition activity that defines reading a value of an output signal from a test sensor and assigning the value to a variable; a data calculation activity that defines calculating a value and assigning the calculated value to a variable; and a data writing activity that defines writing a value to a non-transitory computer-readable medium.

One embodiment of a testing system includes a test machine, at least one computing device, a test program generator and a system controller. The test machine includes a controllable element configured to apply a load and/or a displacement to a specimen, and a test sensor configured to measure a response from the specimen to the applied load and/or displacement or provide feedback for controlling the controllable element. The test program generator is configured to operate on the at least one computing device and is configured to provide a graphical user interface (GUI) on a display device that includes a plurality of workflow elements. The workflow elements include test controls and one or more workflow controls. The test controls include one or more controllable element activities each used to control an aspect of a test machine of the testing system relating to the application of a load and/or displacement to a specimen using a controllable element of the test machine during a test operation, and one or more data activities each relating to monitoring or acquiring data generated during a test operation. The workflow controls are each configured to control a path along which process steps are performed include a group workflow. The test program generator is also configured to create a test workflow in a test workflow window of the GUI comprising: adding a first plurality of the test controls to the test workflow based on user input to the GUI; defining parameters of the first plurality of test controls in the test workflow based on user input to the GUI; adding the group workflow to the test workflow based on user input to the GUI; adding a second plurality of the test controls to the group workflow of the test workflow based on user input to the GUI; and defining parameters of the second plurality of the test controls based on user input to the GUI. The test program generator is also configured to create the test program based on the test workflow, which includes instructions for performing a test operation corresponding to the test workflow, and save the test program in a non-transitory computer readable medium. The system controller is configured to operate on the at least one computing device and perform the test operation in response to executing the saved test program comprising: controlling the controllable element of the test machine based on the instructions corresponding to the one or more controllable element activities of the test workflow; and/or monitoring or acquiring data relating to the test sensor based on the instructions corresponding to the one or more data activities of the test flow.

In one embodiment, the test program generator is configured to save the group workflow of the test workflow to the non-transitory computer-readable medium based on user input to the GUI to form a saved group workflow having the defined parameters.

In one embodiment, the test program generator is configured to present the saved group workflow in the GUI.

In one embodiment, the toolbox includes one or more saved group workflows, each saved group workflow comprising a group test workflow that includes a plurality of the test controls each having defined parameters, and the test program generator is configured to add one of the saved group workflows from the toolbox to the test workflow based on user input to the GUI.

In one embodiment, the controllable element comprises an actuator and adding the second plurality of the test controls to the group workflow of the test workflow includes adding one or more of the controllable element activities to the group workflow of the test workflow selected from the group consisting of a dwell activity, a ramp activity, a cycle activity and a custom waveform activity.

In one embodiment, adding the second plurality of the test controls from the toolbox to the group workflow of the test workflow includes adding one or more of the data activities to the group workflow of the test workflow selected from the group consisting of: a data acquisition activity that defines reading a value of an output signal from a test sensor and assigning the value to a variable; a data calculation activity that defines calculating a value and assigning the calculated value to a variable; and a data writing activity that defines writing a value to a non-transitory computer-readable medium.

Another embodiment of the present disclosure is directed to a computer-implemented method for generating a test program for a testing system, in which a graphical user interface (GUI) is provided on a display device and includes a plurality of workflow elements. The workflow elements include: test controls including one or more controllable element activities each used to control an aspect of a test machine of the testing system relating to the application of a load and/or displacement to a specimen using a controllable element of the test machine during a test operation, and one or more data activities each relating to monitoring or acquiring data generated during a test operation; and one or more workflow controls each configured to control a path along which process steps are performed including a group workflow. A test workflow is created in a test workflow window of the GUI including: adding a first plurality of the test controls to the test workflow based on user input to the GUI; defining first parameters of the first plurality of the test controls based on user input to the GUI; and adding one of the saved group workflows, which includes a second plurality of the test controls having second parameters that are predefined to the test workflow based on user input to the GUI. A conflict check is performed comprising:

comparing the first parameters to the second parameters; detecting at least one conflict based on one or more mismatches between the compared first and second parameters; and generating one or more notifications in the GUI identifying the detected at least one conflict. The test program is created based on the test workflow, which includes instructions for performing a test operation corresponding to the test workflow, and the test program is saved in a non-transitory computer readable medium.

In one embodiment, generating the one or more notifications includes presenting at least one conflict resolution configured to change at least one of the first parameters or at least one of the second parameters in response to a user input to the GUI to resolve the at least one conflict.

In one embodiment, the first parameters and the second parameters are selected from the group consisting of: a name; and a property.

In one embodiment, the first and the second parameters define one or more variables selected from the group consisting of: a current value of an output from a test sensor of the test machine; a stored value of an output from a test sensor of the test machine; and a calculated value.

In one embodiment, the first and the second parameters define one or more resources selected from the group consisting of: a control channel of the test machine; a control mode of the test machine; a test sensor of the test machine; and a data input to the test machine.

In one embodiment, performing the conflict check comprises an action selected from the group consisting of: comparing a name of the first parameters to a name of the second parameters; and comparing a property of the first parameters to a property of the second parameters.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter. The claimed subject matter is not limited to implementations that solve any or all disadvantages noted in the Background.

### BRIEF DESCRIPTION OF THE DRAWINGS

FIG. 1 is a simplified diagram of an example of a dynamic testing system, in accordance with embodiments of the present disclosure.

FIGS. 2-4 are simplified diagrams illustrating example screenshots of a graphical user interface produced by a test program generator, in accordance with embodiments of the present disclosure.

FIG. 5 is a flowchart illustrating a computer-implemented method for generating a test program for a testing system, in accordance with embodiments of the present disclosure.

FIG. 6 is a flowchart illustrating an example of a computer-implemented conflict check method, in accordance with embodiments of the present disclosure.

FIG. 7 is a simplified diagram of an example notification, in accordance with embodiments of the present disclosure.

FIG. 8 is a simplified diagram illustrating an example computing environment or computing device, in accordance with embodiments of the present disclosure.

### DETAILED DESCRIPTION OF ILLUSTRATIVE EMBODIMENTS

Embodiments of the present disclosure are described more fully hereinafter with reference to the accompanying drawings. Elements that are identified using the same or similar reference characters refer to the same or similar elements. The various embodiments of the present disclosure may, however, be embodied in many different forms and should not be construed as limited to the embodiments set forth herein. Rather, these embodiments are provided so that this disclosure will be thorough and complete, and will fully convey the scope of the present disclosure to those skilled in the art.

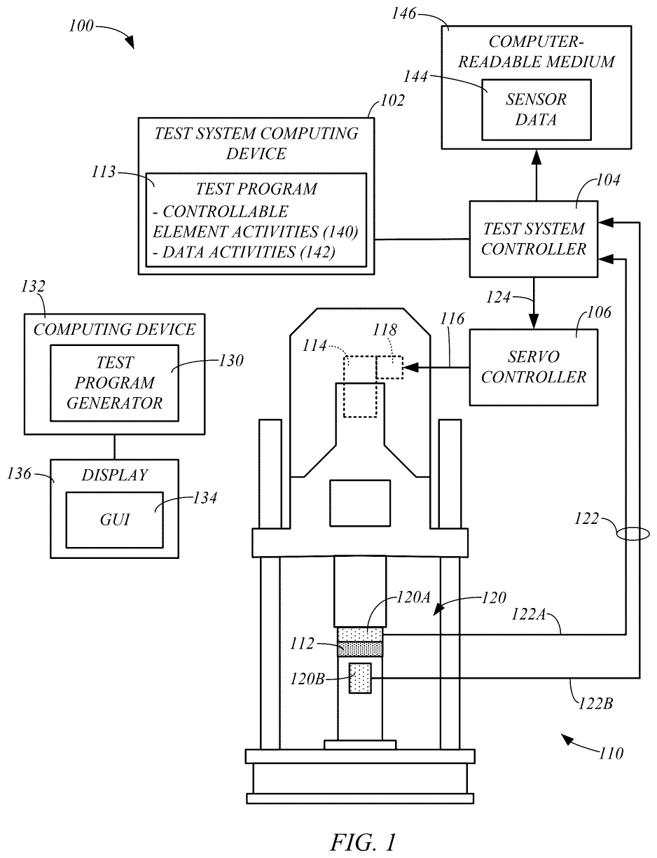

FIG. 1 illustrates an example of a dynamic testing system 100, which may include a testing system computing device 102, a testing system controller 104, a servo controller 106 and one or more test machines 110 for performing a test operation on a specimen 112 (e.g., material sample, substructure or components, etc.). A test program 113, which defines a test operation, may be executed by the testing system computing device 102, to generate instructions for controlling the testing system controller 104 to perform the test operation.

The illustrated example test machine 110 includes at least one controllable element or actuator 114 (e.g., hydraulic, pneumatic and/or electric) for imparting displacements and/or loads to a directly or indirectly coupled specimen 112 to excite the specimen 112. A controlled device 118 (e.g. servo valve, power controller) may be used to control the actuator 114 to provide a desired specimen excitation based on actuator command signals 116 generated by the servo controller 106.

One or more test sensors 120 provide feedback 122 to the testing system controller 104 in the form of a measured or an actual response to an actuation of the specimen 112 during the test operation. The one or more test sensors 120 may include one or more transducers on the test specimen 112 or the test machine 110, such as a force transducer 120A (e.g., load cell, torque transducer, pressure transducer, etc.), and/or one or more other test sensors 120B, such as a displacement sensor, an extensometer, an accelerometer, or another test sensor, for example. The test sensors 120 provide measured or actual responses 122, such as signals 122A and 122B, as feedback to the testing system controller 104.

During a test operation, the testing system controller 104 may provide a reference or control signal 124 to the servo controller 106, which issues a corresponding actuator command signal 116 to the controlled device 118, which in turn drives movement of the actuator 114. The one or more test sensors 120 provide the feedback 122 to the testing system controller 104, which adjusts the control signal 124 according to the test procedure defined by the test program 113. It is understood that the dynamic testing system 100 shown in FIG. 1 is a simplified system (single channel case), and that embodiments of the present disclosure apply to systems 100 comprising multiple channels, such as multiple test sensors 120 or feedback components, and multiple actuators 114, for example.

The test program 113 may be generated using a test program generator 130 operated on a computing device 132, such as the testing system computing device 102, for example. The test program generator 130 may be configured to generate a graphical user interface (GUI) 134 on a display device 136. As discussed below, a user may define a test workflow of a test procedure through the GUI 134, which is used by the test program generator 130 to create the test program 113. Accordingly, the test program generator 130 may employ a “workflow” type program for creating the test program 113, such as described in U.S. Publication No. 20100077260, which is incorporated herein by reference in its entirety. The created test program 113 may be saved to a non-transitory computer-readable medium of the testing system computing device 102 or another suitable storage medium.

The execution of the test program 113 by the testing system computing device 102 causes the testing system computing device 102 to deliver instructions to the testing system controller 104 to perform a test operation or test workflow through the control of the one or more actuators 114 and other components of the one or more test machines 110 of the system 100. For example, the test program 113 may include one or more conventional test controls, such as controllable element activities 140 that define an application of a load (a tension, a compression, and/or a torsion) and/or a displacement to a specimen 112 using one or more of the controllable elements or actuators 114. The test controls may also include data activities 142 that may define data monitoring or data acquisition activities relating to the responses 122 generated by test sensors 120, variable calculations, and data writing activities, in which sensor data 144 or other data is written to a non-transitory computer-readable medium 146.

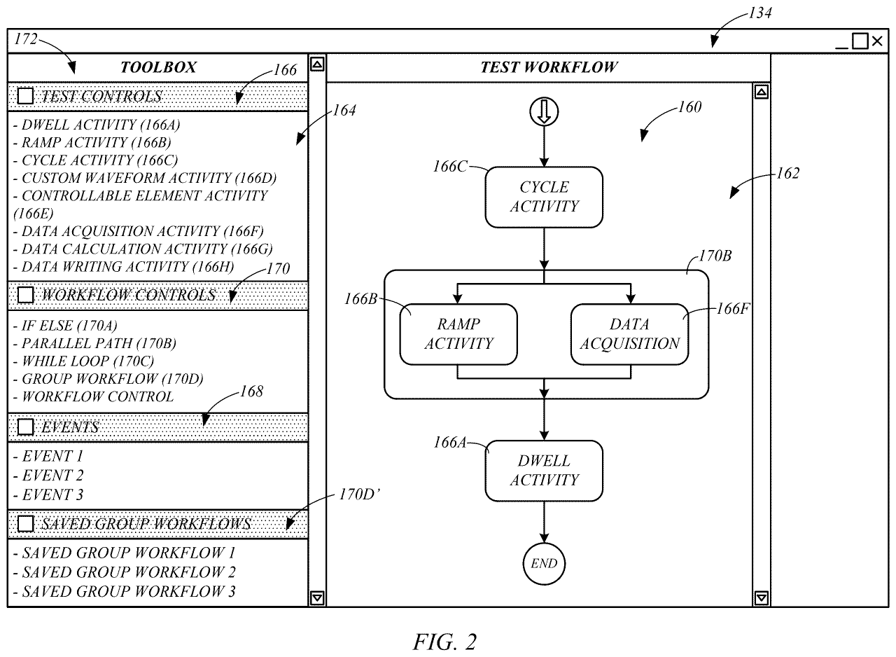

FIGS. 2-4 are simplified diagrams illustrating example screenshots of a GUI 134 produced by the test program generator 130 and displayed on the display device 136, in accordance with embodiments of the present disclosure. The illustrated GUI 134 includes an example test workflow 160 within a workflow window 162. The test workflow 160 is generally a flowchart with a beginning, an end, and a sequential flow from start to finish of a test procedure that may be performed using one or more of the test machines 110. The building blocks of the test workflow 160 comprise workflow elements 164 that define test controls 166, events 168, workflow controls 170, and/or other workflow elements 164.

The workflow elements 164 may be contained within a toolbox window 172 of the GUI 134. A graphical icon (not shown) may be assigned to each workflow element 164. The test workflow 160 may be created by adding one or more of the workflow elements 164 to the workflow window 162 and interconnecting the workflow elements 164 based on user input to the GUI 134 (e.g., drag and drop operation) to form a flowchart (visual depiction) of the test procedure that forms the test workflow 160. The workflow elements 164 generally include conventional parameters that may be defined by the user through the GUI 134, such as when they are added to the test workflow 160.

The test controls 166 generally include the controllable element activities 140 mentioned above that define an application of a load and/or a displacement to a specimen 112 using one or more of the controllable elements or actuators 114 of one or more test machines 110. Examples of conventional test controls 166 include a dwell activity 166A, a ramp activity 166B, a cycle activity 166C, a custom waveform activity 166D, and other conventional controllable element activities (e.g., sweep activity, etc.), which are represented by the controllable element activity 166E.

The dwell activity 166A directs the testing system controller 104 to issue a control signal 124 to hold a level for a specified duration of time. Accordingly, the dwell activity 166A is defined by parameters that include properties of the hold level and the time period that may be defined through user input to the GUI 134.

The ramp activity 166B drives a control signal 124 from its current end-level state to a specified end level within a specified amount of time. The user-defined parameters of the ramp activity 166B include the specified end level property and the specified amount of time property.

The cycle activity 166C directs the testing system controller 104 to issue a control signal 124 that cycles between two different end levels at a specified frequency, using a specified wave shape, for a specified number of cycles. Two end levels form one cycle. The number of cycles determines the required number of end levels. The frequency determines the speed required to achieve the end levels. Accordingly, the user-defined parameters include properties of the cycle activity 166C, such as the frequency, the wave shape and the number of cycles.

The custom waveform activity 166D directs the testing system controller 104 to issue a control signal having a series of ramp and hold segments to make up a custom trapezoid waveform. Each ramp can have a different duration and end level, and each hold can have a different duration. The shape of the ramp segment is linear. The number of cycles determines how many times the entire custom waveform is generated. Thus, example user-defined parameters of the custom waveform activity 166D include properties, such as the ramp duration and end level, the period of each hold, and the number of cycles.

The test controls 166 may also include one or more activities corresponding to the data activities 142 mentioned above, such as a data acquisition activity 166F, a data calculation activity 166G and a data write activity 166H. The data acquisition activity 166F configures the testing system controller 104 to obtain sensor data 144 based on a sensor signal 122 output from a test sensor 120 and store the obtained data in a non-transitory computer-readable medium 146 under a user-defined variable. Thus, the obtained sensor data 144 may include a sensed value corresponding to a sensed condition by one of the test sensors 120, such as a sensed load from a load cell, a sensed torque from a torque transducer, a sensed pressure from a pressure transducer, a sensed displacement from a displacement sensor, a sensed force or displacement from an extensometer, a sensed acceleration from an accelerometer, or another sensed value.

The data acquisition activity 166F includes conventional parameters that identify one or more resources through which the data is acquired, such as a test sensor 120, or an input channel to the testing system controller 104, for example. Thus, the user-defined parameters of the data acquisition activity may include conventional parameters relating to the resource, such as a name or identifier of the resource and conventional properties of the resource, such as signal values, for example.

The data acquisition activity 166F may require at least one trigger and one signal. The trigger defines the method for acquiring data points (e.g. timed acquisition at a selected sample rate, when the value changes by a selected amount, etc.). The total number of data points to acquire can be prescribed. The data acquisition activity 166F is typically performed in parallel with one or more of the controllable element activities 140, such as the ramp 166B, as indicated in the example test workflow 160 of FIG. 2.

Conventional user-defined parameters or settings relating to the data acquisition activity 166F include a name of the variable and various properties of the variable. Conventional variable properties include a type (e.g., number, text, array, etc.), a dimension (e.g., frequency, length, force, acceleration, etc.), unit (e.g., hertz, millimeters, newtons, count, etc.), a default value, a format (e.g., a format type such as fixed or variable, a digit type such as decimal or integer, a number of digits, etc.), and/or other properties.

The data calculation activity 166G configures the testing system controller 104 to perform a calculation or function (e.g., strain calculation) based on the values obtained through one or more of the data acquisition activities 166F (e.g., specimen length, force, etc.) and store the calculated values in a non-transitory computer-readable medium 146. The calculated value may be assigned to a calculated variable used in the test workflow 160.

Conventional user-defined parameters of the calculated variable include a name and properties, such as the conventional variable properties described above. Additionally, the associated calculation or function includes user-defined parameters, such as the identification of other variables having their own name and properties that are used in the calculation.

The data writing activity 166H configures the testing system controller 104 to perform a write operation 142 of various information (e.g., sensor data 144), such as variables containing sensor data or calculated data, to a designated non-transitory computer-readable medium 146. The data writing activity 166H may include several user-defined parameters, such as a name for the data file to which the data is written, a format in which the data is written (e.g., extensible markup language, comma-separated values, tab-delimited values, text file, etc.), a format of a table or an array in which the data is written, and other properties. These user-defined parameters may be contained in a report template to simplify the data reporting process.

The event workflow elements 168 are conventional workflow elements 164 that generally cause the testing system controller 104 to trigger a start or a stop to a portion of a test procedure. For example, the events 168 may function as a trigger based on when a calculated variable changes by more than a specified amount in a cycle, or when a comparison between two values is consistent within a defined percentage for a defined number of cycles (e.g., detection of a stable cycle). Likewise, an event 168 may be based on the detection of an upper or a lower limit in a signal, such as an output signal 122 from one of the test sensors 120. Events 168 may also include the detection of particular program states or state changes, for example. Accordingly, the user-defined parameters of the events 168 may include names of one or more variables or calculated variables, and properties relating to the trigger event, for example.

The workflow controls 170 generally control a manner in which process steps are performed. For example, the workflow controls 170 may utilize conditional logic to establish one or more conditions that, if met, result in the performance of one or more events 166 or activities 168. Examples of some conventional workflow controls 170 include an if else workflow control 170A, a parallel path workflow control 170B, a while loop workflow control 170C, and/or other conventional workflow controls 170, such as a periodic time event, a repeat loop, etc.

When one of the workflow controls 170 is added to the test workflow 160 in the test workflow window 162, the user may define various conventional parameters of the added workflow control 170 through input to the GUI 134. For example, the if else workflow control 170A may include parameters corresponding to properties that define the “if” condition that results in the performance of the “else” condition, such as a parameter relating to a value of a variable corresponding to a sensor signal 122 meeting a certain condition, such as the value exceeding a threshold value. Similarly, the while loop workflow control 170C has associated conventional parameters for defining properties of the condition that maintains the performance of the loop and/or the condition that stops the performance of the loop. The periodic time event workflow control includes associated conventional parameters that specify properties for the triggering of the event, and the repeat loop workflow control includes conventional parameters that may define the number of times a process is repeated, for example.

A test workflow 160 is conventionally created in the test workflow window 162 based on user input to the GUI 134, such as pointing and clicking, dragging and dropping, keyboard input, or other conventional user input. The user input to the GUI 134 places a plurality of the workflow elements 164 in the test workflow window 162 and connects the elements 164 together to form a test workflow 160 that defines a test procedure. Additionally, the user defines parameters of the added workflow elements 164 in a conventional manner through the GUI 134.

For example, to form the example test workflow 160 of FIG. 2, the user adds to the workflow window 162 based on user input to the GUI 134 a cycle activity 166C, a parallel path 170B, a ramp activity 166B and a data acquisition activity 166F to the parallel path 170B, and a dwell activity 166A. The user may define the parameters of the workflow elements 164 of the test workflow 160 when they are added to the test workflow window 162 or after they have been added, through input to the GUI 134.

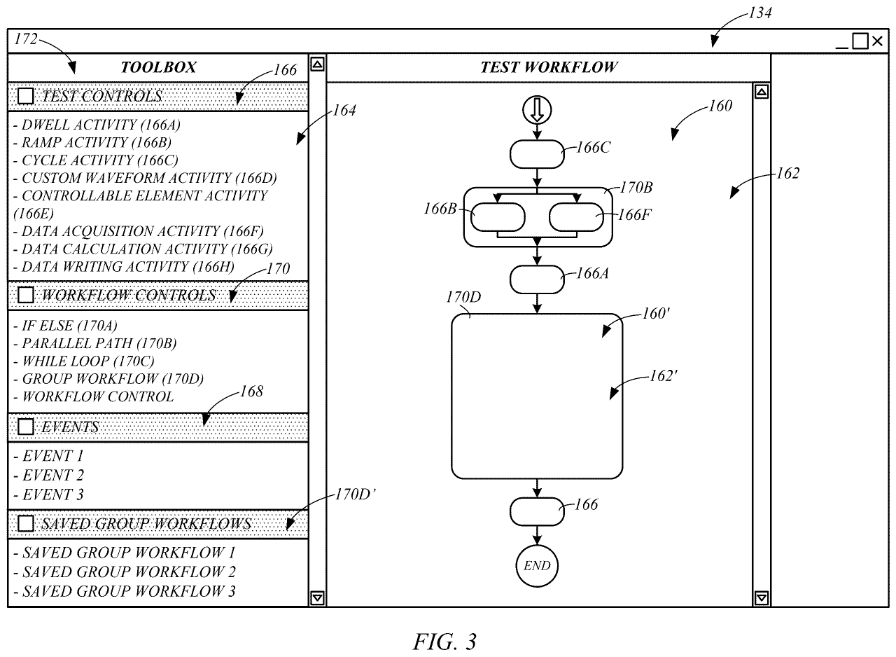

Embodiments of the present disclosure operate to improve the process for creating the test workflow 160 through the introduction of a group workflow 170D, which may be presented in the GUI 134 under the workflow controls 170 of the toolbox 172, for example, as shown in FIG. 2. The group workflow 170D may be added to the test workflow 160 in the test workflow window 162 based on user input to the GUI 134 in the same manner as the other workflow elements 164, such as indicated in FIG. 3.

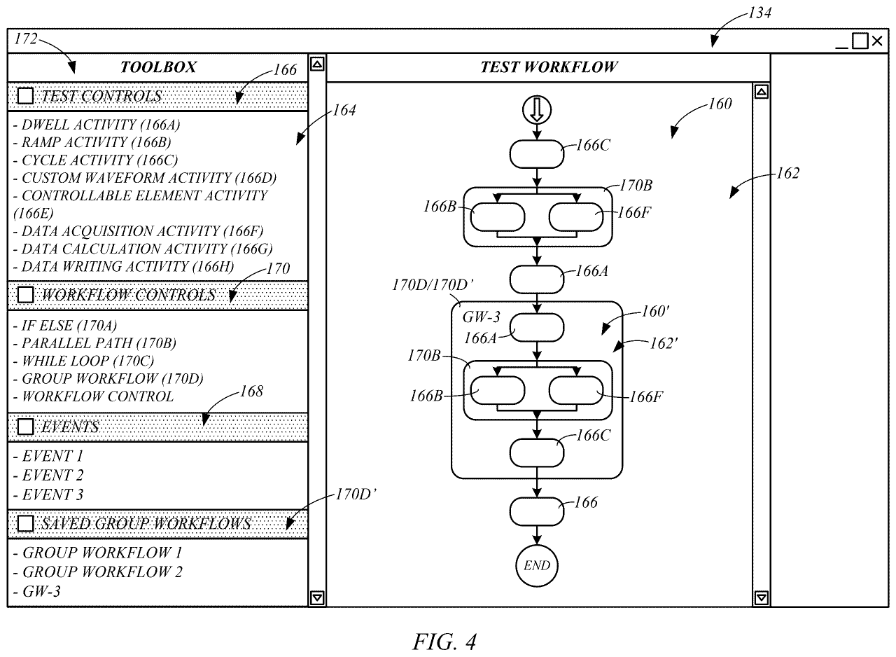

The group workflow 170D generally forms a secondary test workflow window 162′ in which a secondary test workflow 160′ is created within the primary test workflow 160. The user defines the secondary test workflow 160′ by adding the workflow elements 164 in the manner described above with regard to the creation of the test workflow 160. FIG. 4 illustrates the addition of several example workflow elements 164 to the secondary test workflow 160′ in response to user input to the GUI 134, such as the dwell activity 166A, the parallel path activity 170B, the ramp activity 166B, the data acquisition activity 166F, and the cycle activity 166C, to form an example of the secondary test workflow 160′ within the primary test workflow 160.

The parameters of the group workflow 170D include a name of the added group workflow 170D (e.g., “GW-3”), and the parameters or properties of the workflow elements 164 contained within the secondary test workflow window 160′, which are entered through user input to the GUI 134. Thus, in the example shown in FIG. 4, the user completes the secondary test workflow 160′ by entering the parameters of the dwell activity 166A, the ramp activity 166B, the data acquisition activity 166F, etc.

In some embodiments, the added group workflow 170D may be saved by the test program generator 130 to a non-transitory computer-readable medium based on user input to the GUI 134, such as through a pop-up menu produced by right-clicking the group workflow 170D or through another conventional user-input process. In one embodiment, the test program generator 130 presents the saved group workflows 170D′ in the GUI 134, as indicated in FIG. 4. The saved group workflows 170D′ include their secondary test workflows 160′ as well as the parameters that were previously defined by the user.

The saved group workflows 170D′ may be added to a test workflow 160 in a similar manner as other workflow elements 134. Thus, one alternative to adding a new and undefined group workflow 170D to the test workflow window 162 (FIG. 3) and going through the process of adding the workflow elements 164 and individually defining the parameters of the workflow elements 164 as discussed above, the user may select one of the saved group workflows 170D′ having predefined parameters and add it to the test workflow 160 in the same manner as other workflow elements to form the test workflow 160. Thus, the saved group workflow 170D′ named “GW-3” may be added from the saved group workflows in the GUI 134 to the test workflow window 162 along with other workflow elements 164 to form the test workflow 160 shown in FIG. 4, for example.

In some embodiments, the workflow elements 164, such as a new group workflow 170D or a saved group workflow 170D′ that has been added to a primary test workflow 160, may be moved within the test workflow window 162 based on user input to the GUI, such as a drag and drop input to the GUI 134. This allows the user to organize the elements 164 as desired to form the primary test workflow 160.

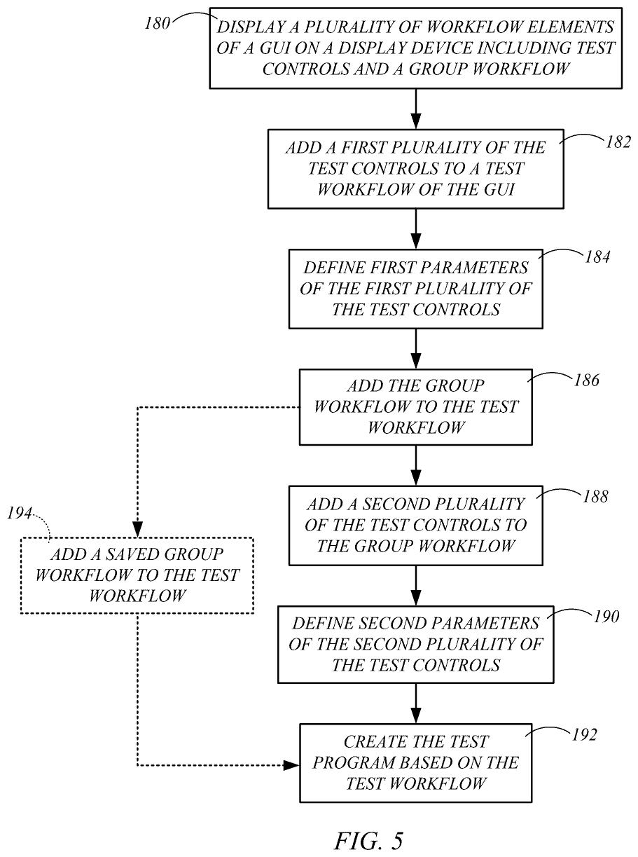

One embodiment of the computer-implemented method described above for generating a test program 113 for a testing system 100, such as using the test program generator 130, is illustrated in the flowchart of FIG. 5. At 180 of the method, a plurality of the workflow elements 164 of the GUI 134 are displayed on a display device 136. The workflow elements 164 include test controls 166, which include one or more controllable element activities 140 and one or more data activities 142. Additionally, the test controls 166 include one or more workflow controls 170 that include a group workflow 170D, as discussed above. At 182, a first plurality of the test controls 166 is added to the test workflow 160 (e.g., the dwell activity 166A, the ramp activity 166B, etc.) and first parameters (e.g., a name and/or a property) of the first plurality of test controls 166 are defined at 184, based on user input to the GUI 134, such as discussed above with regard to FIG. 2.

At 186 of the method, the group workflow 170D is added to the test workflow 160, as discussed above with reference to FIG. 3. At 188, a second plurality of the test controls 166 is added to the secondary test workflow 160′ of the group workflow 170D, and second parameters of the second plurality of the test controls 166 are defined at 190, based on user in put to the GUI 134, as discussed above with reference to FIG. 4.

In another embodiment of the method, steps 186, 188 and 190 may be replaced with a step 194 of adding one of the saved group workflows 170D′, such as the saved group workflow “GW-3” to the test workflow 160 based on user input to the GUI 134. Accordingly, the use of the saved group workflows 170D′ can improve the efficiency at which the test workflow 160 and the test program 113 are created.

Embodiments of the present disclosure include creating the test workflow 160 in the test workflow window 162 using a combination of one or more of the following techniques: adding one or more test controls 166 directly to the test workflow 160 and defining their parameters (steps 182 and 184); adding a group workflow 170D to the test workflow 160, adding one or more test controls 166 to the group workflow 170D, and defining the parameters of the test controls 166 of the secondary test workflow 160′ (steps 186, 188 and 190); and adding a saved group workflow 170D′ to the test workflow 160 (step 194).

The test program 113 is created by the test program generator 130 based on the test workflow 160, at 192 of the method. The test program 130 may then be saved to a non-transitory computer-readable medium.

It is possible that the predefined parameters of the saved group workflows 170D′ conflict with the user-defined parameters of the non-grouped test controls 166 that have been added to the test workflow 160 within the GUI 134. For example, a name of one of the predefined parameters of the saved group workflow 170D′, such as a name of a variable, a name of a resource (e.g., an input channel, a default value, a variable type, a control mode, a control channel, etc.), may be different from the names in the parameters of the non-grouped test controls 166 of the test workflow 160, and/or a property of one of the predefined parameters may be different from the properties of the parameters of the non-grouped test controls 166 of the test workflow 160. Such conflicts would likely render the test operation defined by the test workflow 160 unusable for its intended purpose or would result in testing system control errors when the test program is executed.

Embodiments of the present disclosure include techniques for identifying conflicts between non-grouped test controls 166 of a test workflow 160 having first parameters, such as the test controls 166A, 166B, 166C and 166F of the example test workflow 160 of FIG. 4, and a saved group workflow 170D′ having second parameters, such as the saved group workflow “GW-3” of the example test workflow 160 of FIG. 4, before the creation of the test program 113 (step 192 of FIG. 5).

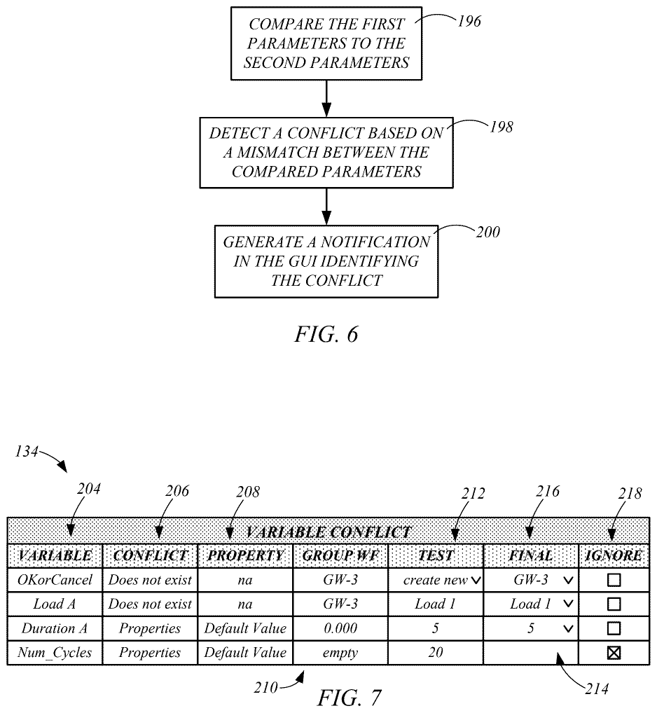

FIG. 6 is a flowchart illustrating an example of a computer-implemented conflict check method that may be performed by the test program generator 130, in accordance with embodiments of the present disclosure. At 196 of the method, one or more of the first parameters are compared to one or more of the second parameters. The parameters of the test controls 166 may be organized in a conventional manner to facilitate this comparison. For example, each of the test controls 166 may list its parameters in a predefined order, or under corresponding “fields” or labels that identify the type of parameter that is listed. This allows the test program generator 130 to compare a given parameter (name or property) of one of the test controls 166 to a corresponding parameter (name or property) of another test control 166, step 196.

At 198, one or more conflicts are detected based on one or more mismatches between the compared parameters. A notification is then generated in the GUI 134 that identifies the detected one or more conflicts at 200 of the method.

In one example of step 196 with reference to the test workflow 160 of FIG. 4, the test program generator 130 compares the parameters (first parameters) of the non-group test controls 166 to the parameters (second parameters) of the test controls 166 of the “GW-3” group workflow 170D′, such as after the user added the saved “GW-3” group workflow 170D′ to the test workflow 160. For this example, the “GW-3” group workflow 170D′ includes test controls 166 that utilize variables “OKorCancel”, “Load A”, “Duration A” and “Num-Cycles”, such as in the data acquisition activity 166F. Thus, step 196 includes a comparison of the names and properties of these variables to variables of the non-group test controls 166 of the test workflow 160. It is understood that the conflict check method may be used to check for conflicts relating to other conventional non-variable related parameters of the test controls 166.

Due to detected conflicts in step 198, a notification is presented in the GUI 134 in step 200. FIG. 7 is a simplified diagram of an example notification 202 that may be presented in the GUI 134, in accordance with embodiments of the present disclosure. The example notification 202 identifies the variables of the second parameters with which a conflict has been detected in column 204, and identifies the particular conflict that was detected in column 206. The notification 202 may include an identification of a property type (e.g., default value, dimension, unit, format, etc.) of the second parameter that is in conflict with the first parameters, as indicated in column 208, an identification of the property value of the second parameter having the conflict, as indicated in column 210 and/or an identification of the conflicting first parameter, such as indicated in column 212.

In some embodiments, the notification 202 may present a conflict resolution 214, such as indicated at column 216, that is configured to change one of the first or second parameters based on user input to the GUI 134 (e.g., drop down menu, etc.) to resolve one or more of the detected conflicts. In some embodiments, the conflict resolution 214 provides the user an option of adjusting the second parameter having a conflict through user input to the GUI 134 (e.g., drop down menu, etc.), as indicated at column 218. In some embodiments, the notification 202 provides the user with the option of ignoring a detected conflict, as indicated at column 220, such as by checking a box in the GUI 134 or based on another suitable user input.

According to the first and second parameters of the test workflow 160 of FIG. 4, the notification 202 may identify conflicts with the name parameters, such as where the variable name of a second parameter does not exist in the first parameters. For example, when the variable name “OKorCancel” or “Load A” of the second parameters does not exist in the first parameters, the conflict is identified in column 206, as shown in FIG. 7. If the second parameters of the test workflow 160 includes a corresponding variable with matching or similar parameters to the non-existent variables, the conflict resolution 214 may present a list (e.g., drop down menu) of the corresponding variables of the non-group test controls 166 in column 212, such as the corresponding variable “Load 1” for the variable “Load A”, as shown in FIG. 7. Where a corresponding variable of the non-group test controls 166 doesn't exist, such as with the variable “OKorCancel”, the conflict resolution 214 may present an option to create a new variable as indicated in column 212, delete the variable, and/or another option. The conflict resolution 214 may allow the user to resolve the conflict by identifying a final resolution in column 216, such as the selection to use or maintain the second parameter, as with the variable “OKorCancel” or change the conflicting variable of the group test controls 166 to one of the corresponding variables of the non-group test controls 166, as with the variable “Load A”, such as by changing the name “Load A” to “Load 1” in the group test controls 166, for example.

The example notification 202 illustrates a conflict between the properties of the second parameters of the variables “Duration A” and “Num_Cycles” and the properties of the first parameters for the corresponding variables, as indicated in column 206. Here, the conflict is with the default value property, as indicated in column 208. The second parameters define the default value of the variable “Duration A” as “0.000” whereas the first parameters define the default value of the variable “Duration A” as “5”, and the second parameters define the default value of the variable “Num_Cycles” as being empty whereas the first parameters define the default value of the variable “Num_Cycles” as “20”, as indicated in columns 210 and 212. The user resolved the conflict regarding the variable “Duration A” by setting the default value property of the second parameters to “5” through a section in column 216 of the conflict resolution 214. With regard to the conflict with the variable “Num_Cycles”, the user chose to ignore and not resolve the conflict by checking the corresponding box in column 218. The user may resolve this and other conflicts at a later time by directly adjusting the second parameters or by initiating another conflict check by the test program generator 130, for example.

After the test program is created in step 192, which may occur after performing a conflict check and resolving any detected conflicts, the test program 113 may be saved to a non-transitory computer-readable medium, such as that of the testing system computing device 102, for example, in accordance with conventional techniques. The test program 113 may then be used (e.g., executed) by the testing system computing device 102 to provide instructions to the testing system controller 104 to perform a test operation through the control of one or more of the test machines 110, as discussed above.

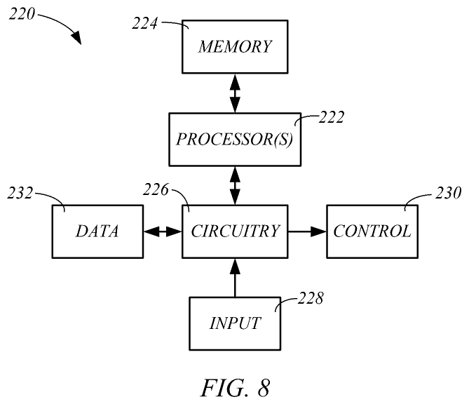

FIG. 8 is a simplified diagram illustrating an example computing environment or computing device 220 in which the testing system computing device 102, the testing system controller 104, the servo controller 106, and the test program generator 130 may be implemented, in accordance with embodiments of the present disclosure. The example computing environment or device 220 may include one or more processors 222 and memory 224, which may be local memory or memory that is accessible to the controller 222. The one or more processors 222 are configured to perform various functions described herein in response to the execution of instructions contained in the memory 224, for example.

The one or more processors 222 may be components of one or more computer-based systems, and may include one or more control circuits, microprocessor-based engine control systems, and/or one or more programmable hardware components, such as a field programmable gate array (FPGA). The memory 224 represents any suitable patent subject matter eligible computer-readable media and does not include transitory waves or signals. Examples of the memory 224 include conventional data storage devices, such as hard disks, CD-ROMs, optical storage devices, magnetic storage devices and/or other suitable data storage devices or computer-readable media.

The computing environment or device 220 may include circuitry 226 for use by the one or more processors 222 to receive input signals 228 (e.g., sensor signals 122, user input from a mouse, keyboard or touchscreen, etc.), issue control signals 230 (e.g., control signals 124, actuator control signals 116, control signals to the display 136, etc.) and/or communicate data 232 (e.g., sensor data 144, etc.), such as in response to the execution of the instructions stored in the memory 224 by the one or more processors 222.

Although the embodiments of the present disclosure have been described with reference to preferred embodiments, workers skilled in the art will recognize that changes may be made in form and detail without departing from the spirit and scope of the present disclosure.

What is claimed is:

1. A computer-implemented method for generating a test program for a testing system comprising:
providing a graphical user interface (GUI) on a display device including a plurality of workflow elements, the workflow elements comprising:
test controls including:
one or more controllable element activities each used to control an aspect of a test machine of the testing system relating to the application of a load and/or displacement to a specimen using a controllable element of the test machine during a test operation; and
one or more data activities each relating to monitoring or acquiring data generated during a test operation; and
one or more workflow controls each configured to control a path along which process steps are performed including a group workflow;
creating a test workflow in a test workflow window of the GUI comprising:
adding a first plurality of the test controls to the test workflow based on user input to the GUI;
defining parameters of the first plurality of the test controls based on user input to the GUI;
adding the group workflow to the test workflow based on user input to the GUI;
adding a second plurality of the test controls to the group workflow of the test workflow based on user input to the GUI; and
defining parameters of the second plurality of the test controls based on user input to the GUI;
creating the test program based on the test workflow, which includes instructions for performing a test operation corresponding to the test workflow; and
saving the test program in a non-transitory computer readable medium.

2. The computer-implemented method according to claim 1, including saving the group workflow of the test workflow to a non-transitory computer-readable medium based on user input to the GUI to form a saved group workflow having defined parameters.

3. The computer-implemented method according to claim 2, wherein the test controls and the saved group workflow is presented in the GUI.

4. The computer-implemented method according to claim 1, wherein:
the GUI includes one or more saved group workflows, each saved group workflow comprising a group test workflow that includes a plurality of the test controls each having defined parameters; and
creating the test program comprises adding one of the saved group workflows to the primary test workflow based on user input to the GUI.

5. The computer-implemented method according to claim 1, including moving the group workflow within the test workflow to another location within the test workflow based on user input to the GUI.

6. The computer-implemented method according to claim 1, wherein:
the controllable element comprises an actuator; and
adding the second plurality of the test controls to the group workflow of the test workflow includes adding one or more of the controllable element activities to the group workflow of the test workflow selected from the group consisting of a dwell activity, a ramp activity, a cycle activity and a custom waveform activity.

7. The computer-implemented method according to claim 6, wherein adding the second plurality of the test controls to the group workflow of the test workflow includes adding one or more of the data activities to the group workflow of the test workflow selected from the group consisting of:
a data acquisition activity that defines reading a value of an output signal from a test sensor and assigning the value to a variable;
a data calculation activity that defines calculating a value and assigning the calculated value to a variable; and
a data writing activity that defines writing a value to a non-transitory computer-readable medium.

8. A testing system comprising:
a test machine comprising:
a controllable element configured to apply a load and/or a displacement to a specimen; and
a test sensor configured to measure a response from the specimen to the applied load and/or displacement or provide feedback for controlling the controllable element; and
at least one computing device;
a test program generator configured to operate on the at least one computing device, the test program generator configured to:
provide a graphical user interface (GUI) on a display device including a plurality of workflow elements, the workflow elements comprising:
test controls including:
one or more controllable element activities each used to control an aspect of a test machine of the testing system relating to the application of a load and/or displacement to a specimen using a controllable element of the test machine during a test operation; and
one or more data activities each relating to monitoring or acquiring data generated during a test operation; and
one or more workflow controls each configured to control a path along which process steps are performed including a group workflow;
create a test workflow in a test workflow window of the GUI comprising:
adding a first plurality of the test controls to the test workflow based on user input to the GUI;
defining parameters of the first plurality of test controls in the test workflow based on user input to the GUI;
adding the group workflow to the test workflow based on user input to the GUI;
adding a second plurality of the test controls to the group workflow of the test workflow based on user input to the GUI;
defining parameters of the second plurality of the test controls based on user input to the GUI; and
create the test program based on the test workflow, which includes instructions for performing a test operation corresponding to the test workflow; and
save the test program in a non-transitory computer readable medium; and
a system controller configured to operate on the at least one computing device and perform the test operation in response to executing the saved test program comprising:
controlling the controllable element of the test machine based on the instructions corresponding to the one or more controllable element activities of the test workflow; and/or
monitoring or acquiring data relating to the test sensor based on the instructions corresponding to the one or more data activities of the test flow.

9. The testing system according to claim 8, wherein the test program generator is configured to save the group workflow of the test workflow to the non-transitory computer-readable medium based on user input to the GUI to form a saved group workflow having the defined parameters.

10. The testing system according to claim 9, wherein the test program generator is configured to present the saved group workflow in the GUI.

11. The testing system according to claim 8, wherein:
the toolbox includes one or more saved group workflows, each saved group workflow comprising a group test workflow that includes a plurality of the test controls each having defined parameters; and
the test program generator is configured to add one of the saved group workflows from the toolbox to the test workflow based on user input to the GUI.

12. The testing system according to claim 8, wherein:
the controllable element comprises an actuator; and
adding the second plurality of the test controls to the group workflow of the test workflow includes adding one or more of the controllable element activities to the group workflow of the test workflow selected from the group consisting of a dwell activity, a ramp activity, a cycle activity and a custom waveform activity.

13. The testing system according to claim 12, wherein adding the second plurality of the test controls from the toolbox to the group workflow of the test workflow includes adding one or more of the data activities to the group workflow of the test workflow selected from the group consisting of:
a data acquisition activity that defines reading a value of an output signal from a test sensor and assigning the value to a variable;
a data calculation activity that defines calculating a value and assigning the calculated value to a variable; and
a data writing activity that defines writing a value to a non-transitory computer-readable medium.

14. A computer-implemented method for generating a test program for a testing system comprising:
providing a graphical user interface (GUI) on a display device including a plurality of workflow elements, the workflow elements comprising:
test controls including:
one or more controllable element activities each used to control an aspect of a test machine of the testing system relating to the application of a load and/or displacement to a specimen using a controllable element of the test machine during a test operation; and
one or more data activities each relating to monitoring or acquiring data generated during a test operation; and
one or more saved group workflows, each including a group workflow comprising a plurality of the test controls having predefined parameters;
creating a test workflow in a test workflow window of the GUI comprising:
adding a first plurality of the test controls to the test workflow based on user input to the GUI;
defining first parameters of the first plurality of the test controls based on user input to the GUI; and
adding one of the saved group workflows, which includes a second plurality of the test controls having second parameters that are predefined to the test workflow based on user input to the GUI;
performing a conflict check comprising:
comparing the first parameters to the second parameters;
detecting at least one conflict based on one or more mismatches between the compared first and second parameters; and
generating one or more notifications in the GUI identifying the detected at least one conflict;
creating the test program based on the test workflow, which includes instructions for performing a test operation corresponding to the test workflow; and
saving the test program in a non-transitory computer readable medium.

15. The computer-implemented method according to claim 14, wherein generating the one or more notifications includes presenting at least one conflict resolution configured to change at least one of the first parameters or at least one of the second parameters in response to a user input to the GUI to resolve the at least one conflict.

16. The computer-implemented method according to claim 15, wherein the first parameters and the second parameters are selected from the group consisting of:
a name; and
a property.

17. The computer-implemented method according to claim 16, wherein the first and the second parameters define one or more variables selected from the group consisting of:
a current value of an output from a test sensor of the test machine;
a stored value of an output from a test sensor of the test machine; and
a calculated value.

18. The computer-implemented method according to claim 17, wherein the first and the second parameters define one or more resources selected from the group consisting of:
a control channel of the test machine;
a control mode of the test machine;
a test sensor of the test machine; and
an input channel to the test machine.

19. The computer-implemented method according to claim 16, wherein performing the conflict check comprises an action selected from the group consisting of:
comparing a name of the first parameters to a name of the second parameters; and
comparing a property of the first parameters to a property of the second parameters.
